(19) United States
(12) Patent Application Publication
(10) Pub. No.: US 2014/0053489 A1
(43) Pub. Date: Feb. 27, 2014

(54) FRAME REINFORCEMENT TO PREVENT WARPING

(71) Applicant: Masonite Corporation, Tampa, FL (US)

(72) Inventors: James BRYANT, Chicago, IL (US); James PFAU, Kirkland, IL (US); Liqun XU, Naperville, IL (US); Elizalde EXCONDE, Bartlett, IL (US)

(21) Appl. No.: 13/800,618

(22) Filed: Mar. 13, 2013

Related U.S. Application Data
(60) Provisional application No. 61/691,509, filed on Aug. 21, 2012.

(51) Int. Cl. E06B 3/72

(52) U.S. Cl. CPC E06B 3/72
USPC 52/456

(57) ABSTRACT

A frame includes a pair of stiles and a pair of rails. A first stile has a first top surface, a first bottom surface, a first exterior surface and a first interior surface. A second stile has a second top surface, a second bottom surface, a second exterior surface and a second interior surface. First and second rails are joined to the first and second stiles. A reinforcement member is joined to the first interior surface.

### CROSS-REFERENCE TO RELATED APPLICATION

This application is related to U.S. Provisional Application Ser. No. 61/691,509 filed Aug. 21, 2012, which is hereby incorporated herein by reference in its entirety and to which priority is claimed.

### FIELD OF THE INVENTION

The invention relates to reinforcing frames to prevent warping.

### BACKGROUND

Doors are increasingly being manufactured from composite components containing fiberglass and thermoset polymers. Typical composite door assemblies include a pair of compression molded exterior skins (also referred to herein and generally known as “facings”). The door skins are mounted on a rectangular frame, frequently formed of wood, that separates and supports the skins in spaced relationship to one another. A hollow space between the skins and bounded by the door frame typically is filled with an insulating material, for example, cardboard, paper, fiberboard, or foam such as polyurethane.

Composite door assemblies provide several advantages over natural wood and steel doors. Composite door assemblies resist rot and corrosion experienced with solid wood and metal doors, respectively. The composite door assemblies also generally are better insulators than solid wood and metal doors. Because of material costs and manufacturing efficiencies, polymer composite door assemblies are considerably less expensive to manufacture than solid wood doors and can be designed to provide a reasonable facsimile of a wood grain on their outer surfaces.

A typical compression molding process used for making commercially available molded door skins involves placing a predetermined weight of sheet molding compound (SMC) charge layers containing a thermosetting polymeric material and fiberglass reinforcement on a lower mold half. An upper mold half is then advanced into engagement with the lower mold half to force the SMC material to fill and to conform to the shape of the mold cavity during compression. The mold halves are heated to a processing temperature, for example about 150° C., to facilitate flow of the resin and cause the thermosetting reaction, also known as curing. Once solidified, the molded door skins are removed from the mold press. Often, the mold dies have contours and embossing features that imprint depressions, grooves, patterns, texture and the like into the molded door skin. The imprinted features often are configured as one or more square or rectangular depressions simulating the perimeter of one or more panels. Alternatively, the facings may be flush. The design flexibility makes composite door assemblies useful for residential and commercial buildings, as well as other uses.

Typically, sheet molding compounds contain a thermosetting resin system such as an unsaturated polyester resin and an unsaturated co-curable reactive monomer, such as styrene. The sheet molding compounds also contain a reinforcing agent, such as glass fibers, often presented as chopped fiberglass and/or a thin fiber mat. Additives commonly combined with sheet molding compounds include catalysts, activating agents, thickening agents, stabilizers, and inert fillers such as calcium carbonate, talc, and wood particles.

The use of conventional compression molded door skins in geographical areas having high or low temperature seasonal climates can be problematic. For example, in areas such as in the northern United States and Canada, low winter temperatures can create a high thermal gradient between, on the one hand, the outside door skin exposed to environmental conditions and, on the other hand, the inside door skin warmed by the internal heating of its associated house or building. This temperature gradient can cause the door skins, particularly the outer door skin, to temporarily or permanently bow or warp. While warping and bowing distances smaller than ¼ inch may be tolerable, greater bowing of the door may violate building codes, blight the door's aesthetic appearance, and impair functionality of the door. For example, a warped door may be difficult to close in a sealing manner with respect to its exterior door frame, to which the doors is pivotally attached, usually by hinges.

### SUMMARY

In accordance with an embodiment, a frame includes a pair of stiles and a pair of rails. A first stile has a first top surface, a first bottom surface, a first exterior surface and a first interior surface. A second stile has a second top surface, a second bottom surface, a second exterior surface and a second interior surface. First and second rails are joined to the first and second stiles. A reinforcement member is joined to the first interior surface.

In accordance with another embodiment a door includes a pair of stiles, a pair of rails, and a pair of door skins. A first stile has a first top surface, a first bottom surface, a first exterior surface and a first interior surface. A second stile has a second top surface, a second bottom surface, a second exterior surface and a second interior surface. First and second rails are joined to the first and second stiles. A reinforcement member is joined to the first interior surface. A first door skin is joined to the first top surface of the first stile and the second top surface of the second stile. A second door skin joined to the first bottom surface of the first stile and the second bottom surface of the second stile.

In accordance with a further embodiment, a method of forming a door includes forming a frame with a reinforcement member and attaching a pair of door skins to the frame. A reinforcement member is joined to an interior surface of a first stile. The first stile and a second stile are joined to a first rail and a second rail to create a door frame having a top surface and a bottom surface. A first door skin is joined to the top surface of the frame. A second door skin is joined to the bottom surface of the frame.

In accordance with a further embodiment, a method of forming a door includes forming a frame with a reinforcement member and a lock block and attaching a pair of door skins to the frame. A lock block and a reinforcement member are joined to an interior surface of a first stile. The first stile and a second stile are joined to a first rail and a second rail to create a door frame having a top surface and a bottom surface. A first door skin is joined to the top surface of the frame. A second door skin is joined to the bottom surface of the frame.

Other embodiments, including apparatus, systems, methods, and the like which constitute part of the invention, will become more apparent upon reading the following detailed description of the exemplary embodiments and viewing the drawings. It is to be understood that both the foregoing general description and the following detailed description are exemplary and explanatory only and therefore not restrictive.

### BRIEF DESCRIPTION OF THE DRAWINGS

The accompanying drawings are incorporated in and constitute a part of the specification. The drawings, together with the general description given above and the detailed description of the exemplary embodiments and methods given below, serve to explain the principles of the invention. In such drawings:

FIG. 1 is a front elevation view of an exemplary door.

FIG. 2 is a perspective, sectional view of the door of FIG. 1 taken along line II.

FIG. 3 is a front elevation view of an exemplary frame and reinforcement member.

FIG. 4 is a perspective, exploded view of the exemplary frame and reinforcement member of FIG. 3.

FIG. 5 is a front elevation view of an exemplary frame and reinforcement members.

FIG. 6 is a front elevation, exploded view of the exemplary frame and reinforcement members of FIG. 5.

FIG. 7 is a front elevation view of an exemplary frame and reinforcement member.

FIG. 8 is a front elevation, exploded view of the exemplary frame and reinforcement member of FIG. 7.

FIG. 9 is a front elevation view of an exemplary frame and reinforcement members.

FIG. 10 is a front elevation, exploded view of the exemplary frame and reinforcement members of FIG. 9.

FIG. 11 is a front elevation view of an exemplary frame and reinforcement members.

FIG. 12 is a front elevation, exploded view of the exemplary frame and reinforcement members of FIG. 11.

FIG. 13 is a front elevation view of an exemplary frame and reinforcement members with more than one reinforcement member attached to a single stile.

FIG. 14 is a front elevation, exploded view of the exemplary frame and reinforcement members of FIG. 13.

FIG. 15 is a front elevation view of an exemplary frame and reinforcement members where the reinforcement member has a height that matches the height of the stile.

FIG. 16 is a front elevation, exploded view of the exemplary frame and reinforcement members of FIG. 15.

### DETAILED DESCRIPTION OF EXEMPLARY EMBODIMENT(S) AND EXEMPLARY METHOD(S)

Reference will now be made in detail to exemplary embodiments and methods of the invention as illustrated in the accompanying drawings, in which like reference characters designate like or corresponding parts throughout the drawings. It should be noted, however, that the invention in its broader aspects is not limited to the specific details, representative devices and methods, and illustrative examples shown and described in connection with the exemplary embodiments and methods. For example, an apparatus and process is described below in connection with fiberglass reinforced polymer (FRP) doors and door skins formed of a composition comprising a thermoset binder in the form of a thermoset composition which is cured into the thermoset binder, and fiberglass being held together by the thermoset binder. However, the process may be used on a variety of articles, particularly door panels made from steel, wood, or wood composites, as well as door lites, side lites, window frames, panels and other building components.

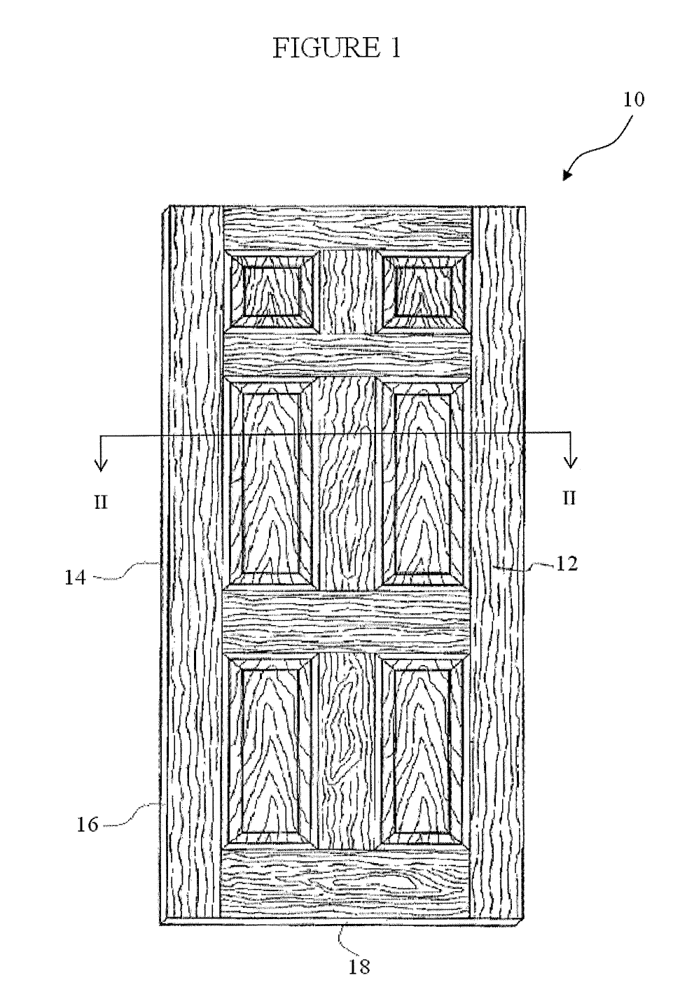

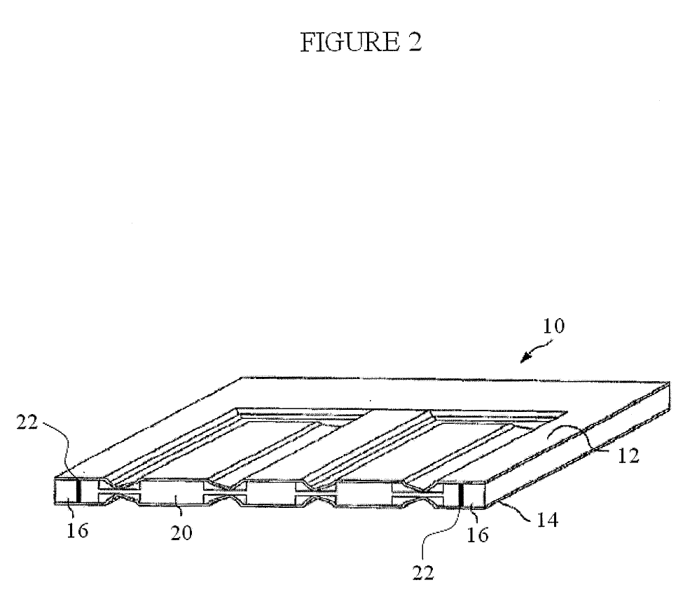

As best shown in FIGS. 1 and 2, a composite door assembly 10 has a multi-panel outer door skin (also referred to herein as facing) 12 and an inner door skin 14. The outer and inner door skins 12, 14 are substantially parallel to and spaced apart from one another. Although the door skins 12, 14 are shown as six-panel substantially rectangular door panels, it should be understood that the door skins may possess single-panel or alternative multi-panel designs, different shapes and configurations, and other appearances. Alternatively, the door skins 12, 14 may have the appearance of a flush door skin with no internal panels. The door skins 12 and 14 may be made from identical or different compositions, and may possess the same or difference appearance as one another.

The composite door assembly 10 may be an exterior entryway door or an interior passageway door of a building, such as a dwelling or commercial property. In view of the excellent thermal stability of the door skins and door assemblies described herein, use of the door assembly 10 as an exterior door is particularly advantageous. Exterior and passageway doors typically have a height of about 6 foot, 8 inches to about 9 feet, more usually about 8 feet, and a width of about 3 to 4 feet, with 3 foot 6 inches being standard width for many passageway doors. Other uses of the composite door assembly 10 include furniture (e.g., cabinet, desk) drawers, furniture doors, and closet doors. Although not shown in the drawings, the composite door assembly 10 may include hardware, such as a handle, knob, or other grasping mechanism, with or without a locking mechanism. Although not shown, openings may be provided in the door skins 12, 14 for receiving door lights (or “lites”) and other door components. The composite door assembly 10 may further include appropriate mounting hardware for its intended use, such as hinges for mounting the composite door assembly 10 to a wall structure (e.g., the frame of a door passageway) or guide rails for allowing sliding movement of the composite door assembly 10. While the embodiments described herein relate primarily to door skins and composite door structures, it should be understood that the disclosed invention is applicable for other composite panels.

Interior surfaces of the door skins 12, 14 are secured to opposite sides of an interior door frame using adhesive, fasteners, other conventional fastening devices and techniques, or a combination thereof. Although not intended to be limiting, the door frame is typically made of wood but sometimes is made of composite materials, man-made pressed wood, metals, or a combination of these and/or other materials. The door frame includes vertical members known as stiles 16 positioned at opposite sides of the door 10 and extending vertically along substantially the entire length of the door 10. The frame further includes horizontal members known as rails 18 positioned at opposite (top and bottom) ends of the door 10 and extending horizontally along substantially the entire width of the door 10. The stiles 16 and rails 18 collectively establish the periphery of the door 10 in the illustrated embodiment. Although not show, the frame may include intermediate stiles and rails hidden from view between the door skins 12, 14. The stiles 16 and rails 18 may be made from a variety of materials including metal, wood, and wood composites, such as fiberboard.

The exterior surfaces of the door skins 12, 14 may be smooth or textured, or a combination thereof. The texture may simulate that of a wood grain design as shown in FIG. 1, or other design. The coloration of the door skins 12, 14 is often a wood toned color, although any base coloration may be used. Stain, paint, or other dye may be applied to the door skins 12, 14, as may print ink grain designs and the like. Alternatively, an image can be printed on the exterior surfaces of the door skins 12, 14, as described in U.S. Pat. No. 7,001,016. The aesthetic appearance and tactile feel of the door skins 12, 14 may be substantially identical to or different from one another. The exterior surfaces of the door skins 12, 14 optionally may be sealed. Optionally, a veneer may be bonded to the exterior surfaces to provide a desired appearance (e.g., color, grain and/or inlay patterns of natural wood).

A core component 20 is optionally situated between the outer and inner door skins 12, 14. As referred to herein, the term “composite door assembly” encompasses within its meaning a door shell (i.e., the frame and door facings 12, 14) with or without the core component 20. The core component 20 may comprise a foam formed of any suitable polymer material which can be injected and formed in place (in situ) between the door skins 12, 14 and the frame, or can be pre-formed and then placed in the frame prior to attachment of one or both of the door skins 12, 14 to the frame. Non-foam materials that may be used include, for example, corrugated pads and other insulation and materials. It should be noted that the interior surfaces of the door skins 12, 14 may be adhered to the core component 20, if present. Optionally, the door assembly 10 may exclude a core, e.g., to provide an empty hollow area between the door skins 12, 14.

The door skins 12, 14 may be made of various resins systems and additives compatible with the present invention, including those materials commonly employed in the door-fabrication industry. According to an exemplary embodiment, the door skins 12, 14 are made of a thermosetting resin composition (or thermoset composition cured into a thermoset binder holding together fiberglass), preferably a sheet molding compound (SMC) or bulk molding compound (BMC) composition. The thermosetting composition preferably contains at least one unsaturated polyester resin and at least one unsaturated, co-curable crosslinking monomer such as styrene that is reactive with the polyester. The unsaturated polyester resin may comprise a polycondensation reaction product of one or more dihydric alcohols and one or more unsaturated polycarboxylic acids. A heat-activated catalyst may be included in the composition. Another example of a suitable thermosetting resin is a polyurethane resin, such as a urethane sheet molding compound, which may comprise, for example, a urethane polymer or prepolymer, a crosslinker and/or linking agent, such as a di- or polyisocyanate, and a catalyst. Other thermosetting resin systems can be used in addition to or as alternatives for the unsaturated polyester, such as phenolic resins, vinyl ester resins, and epoxy resins. Additionally, the resin component of the composition may include one or more thermoplastic polymers, for example, polyolefins such as polyethylene, polypropylene, polystyrene, acrylonitrile-butadiene-styrene (ABS), acrylate-styrene-acrylonitrile (ASA), and others.

The composition may include low shrinkage and low profile additives, organic initiators (e.g., tertiary-butyl peroxybenzoate), thickening agents (e.g., oxides, hydroxides, and alcolates of magnesium, calcium, aluminum), stabilizers, inhibitors, fillers, reinforcements, nanocomponents (see U.S. Pat. Appln. Pub. No. 2008/0016819 to Xu et al., “Nano-composite door facings, and related door assemblies and methods”), and other additives. Examples of low profile additives include thermoplastic polymers, such as saturated polyesters, polystyrene, polyvinyl acetate, and copolymers and terpolymers of the same. Other low profile additives known in the art may also be included.

The fiberglass may be either treated or untreated. The fibers may have a length in a range of, for example, about 3 mm to about 7.62 cm (about 3.0 inches). The glass may be blended into the composition, and chopped into fibers of variable length during an extrusion process. Alternatively, the fibers may have a substantially uniform length. Pre-chopped glass fibers having a particular length may also be used. The chopped fibers may be mixed into the composition during blending. Fiberglass is often found in many commercial sheet molding compounds, and often is present as 1 inch or half inch chopped fiberglass.

Fillers and reinforcements may be incorporated to serve various purposes, including extending the resin, improving mold flow, and/or imparting desired characteristics and mechanical properties to the finished product. Examples of other fillers that may be included in the composition are calcium carbonate, clay, graphite, magnesium carbonate, talc, and mica, including muscovite mica or phlogopite mica. It is often desirable from a cost-savings standpoint to incorporate at least as much mica as fiberglass into the composition.

Additional examples of fillers and reinforcements include graphite, aramids, and organic fibrous additives, in particular cellulosic materials. Suitable organic fibrous additives include wood powder or wood flour, such as provided by relatively small particles of pine and other suitable inexpensive woods, such as oak, cherry, maple, gum and combinations of the same or other woods. Other fibrous organic materials may also be used, including but not limited to straw, rice husks, and knaff. The organic fibrous additive component may comprise a mixture of wood and other fibrous organic materials. The additive may be sized to pass through an 80 mesh sieve, although different sizes may be used. The organic fibrous material may be a by-product of other wood manufacturing processes. For example, the organic fibrous material may be considered to be part of the waste stream of a manufacturing facility. Use of waste material has significant cost and environmental benefits. The filler and reinforcement materials may take various physical shapes, such as fibrous, microspheres, or one or more mats.

The SMC composition may be embodied to constitute, for example, about 15 to about 25 weight percent of the thermosetting resin composition, about 10 to about 20 weight percent low profile additive, about 13 to about 20 weight percent reinforcement, and about 30 to about 50 weight percent filler, and optionally other ingredients, such as, for example, mold release agents, shelf inhibitors, wetting agents, homogenizers, UV retardants, pigments, fire retardants, thickening agents, antioxidants, antistatic metals, colorants, and other additives and fillers described above. Concentrations may be adjusted as warranted for obtaining desired properties.

Any suitable molding technique may be employed for compressing and shaping door skins 12, 14, including, for example, compression molding, resin transfer molding, injection compression molding, thermoforming, and injection molding. Generally, compression molding involves introducing the pre-blend and/or unblended components onto a lower die, the moving one or both dies towards the other to form a closed cavity. The dies may possess embossing structures and texture designed to transfer embossments and grain to the molded door, as is known in the art. During pressing, the components are pressed together between the upper and lower dies and shaped by application of heat and pressure. Sheet molding compounds are often pressed within a temperature range of about 135° C. (275° F.) to about 177° C. (350° F.), often about 138° C. (280° F.) to about 160° C. (320° F.), although temperatures will depend on the composition of the sheet molding compound. The dies exert a pressure on the composition of, for example, about 1000 to about 2000 psi. The pressing operation often lasts, for example, about 30 seconds to 2 minutes.

In various exemplary embodiments, one or more reinforcement members 22 are provided to help prevent or reduce bowing or warping in the assembled door 10. The reinforcement member 22 may be a solid piece of flat stock material, though in certain embodiments the reinforcement member 22 may be hollow or one have holes or voids foamed therein. The reinforcement member 22 may have a generally rectangular shape, though varies shapes or rounded edges may also be used.

The reinforcement member 22 may be made from a variety of materials including metal, for example steel, and composite materials. In an exemplary embodiment, a fiber reinforced polymer material may be used, such as glass reinforced polyester. The glass may be in the form of fibers, rovings, mats or any combination thereof. The reinforcement member may be formed through various methods depending on the type of material. For example, the reinforcement member may be formed through extrusion, pultrusion, molding, or shaping. Use of composite materials is beneficial because they provide greater strength, are cost efficient, and also increases thermal efficiency, both through the material used and for allowing greater room for an insulating core 20.

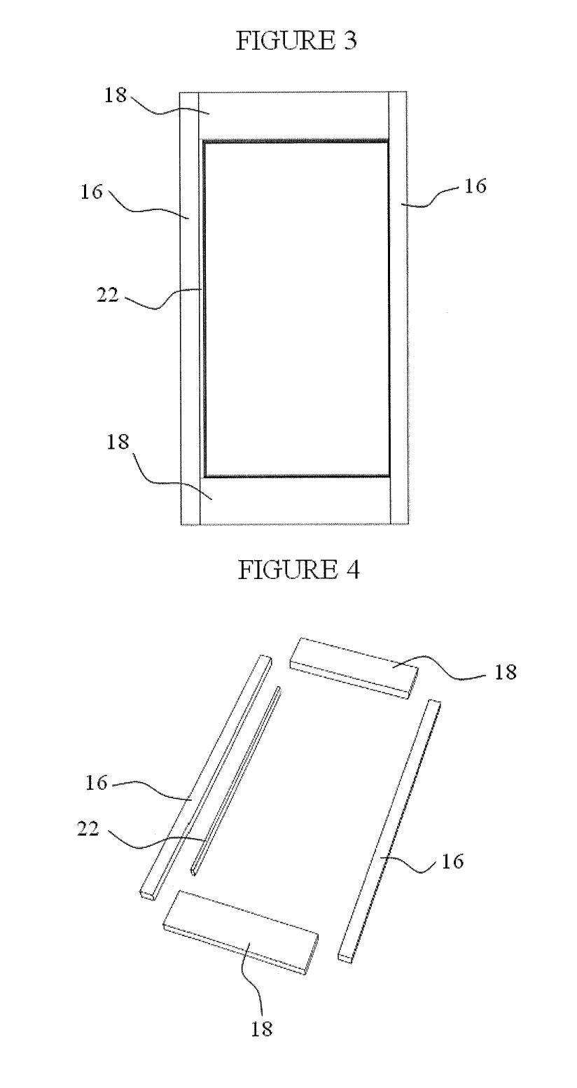

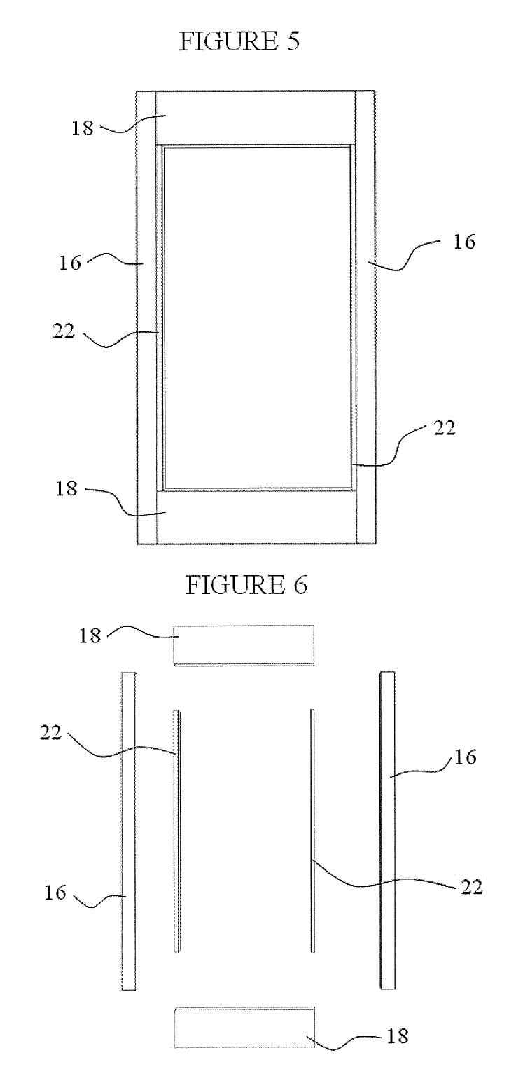

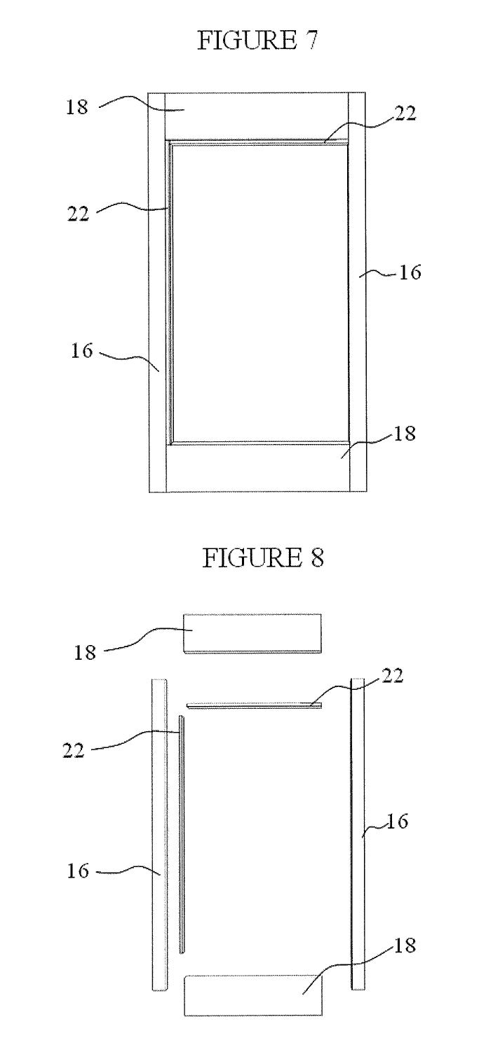

As best shown in FIGS. 3 and 4, a single reinforcement member 22 may be used along a stile 16, for example, the lock-side stile. In certain instances, the single reinforcement member 22 will prevent or reduce bowing while using the minimum number of parts at the least expense. As depicted in FIGS. 5 and 6, a reinforcement member 22 may be joined to each stile 16. Reinforcement members may also be positioned adjacent rails 18 as shown in FIGS. 7 and 8. The reinforcement member 22 may be attached to the stile 16, or rails 18, through an adhesive, a mechanical fastener, or through an interference fit. Any suitable adhesives may be used including cross-linking adhesives, liquid moisture cure adhesives, PUR hot melt adhesives, epoxies, etc.

The length of the reinforcement member 22 may also vary. The reinforcement member 22 positioned along the stile 16 may extend along the length of the stile 16 between the rails 18 as shown in FIGS. 3-8, or it may be shorter in length and positioned anywhere along the stile 16 that needs reinforcement. The reinforcement member 22 positioned along the rail 18 may extend between the reinforcement member 22 positioned along the left stile 16 to the right stile 16. The position and length of each reinforcement member may be varied depending on the needed reinforcement and the length and number of reinforcement members 22. For example, first and second reinforcement members 22 may be positioned against the rails 18 and extend from stile to stile 16, while third and fourth reinforcement members may be positioned along the stiles 16 and extend from the first to the second reinforcement members 22 or vice versa. The length of the reinforcement members may also be shortened an positioned at a desired location. For example, a first reinforcement member 22 may be positioned adjacent the stile 16 and extend from the top rail 18 to the bottom rail 18 while a second reinforcement member is positioned along a rail 18 at the midpoint and extends a certain distance in both directions, but does not reach the stiles 16.

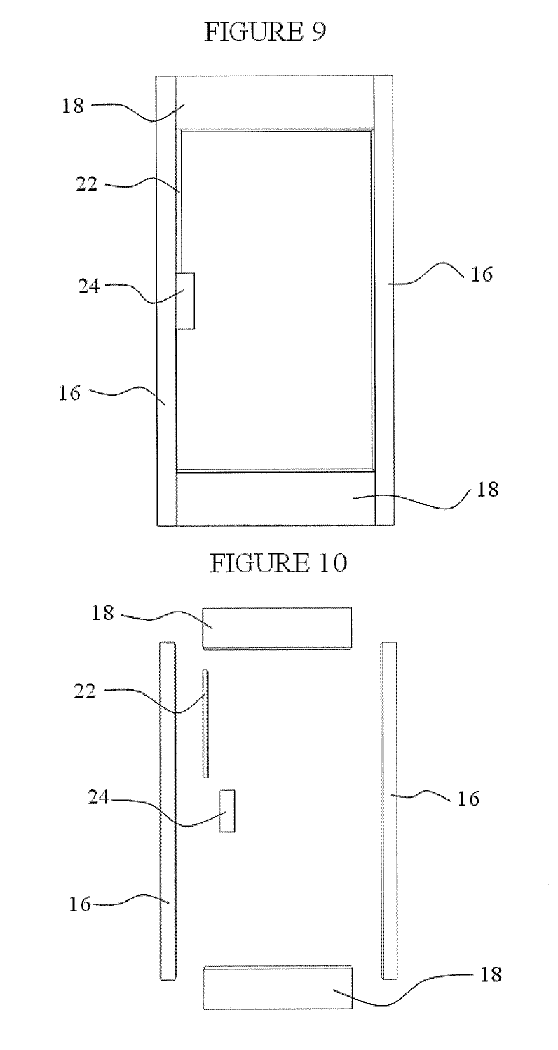

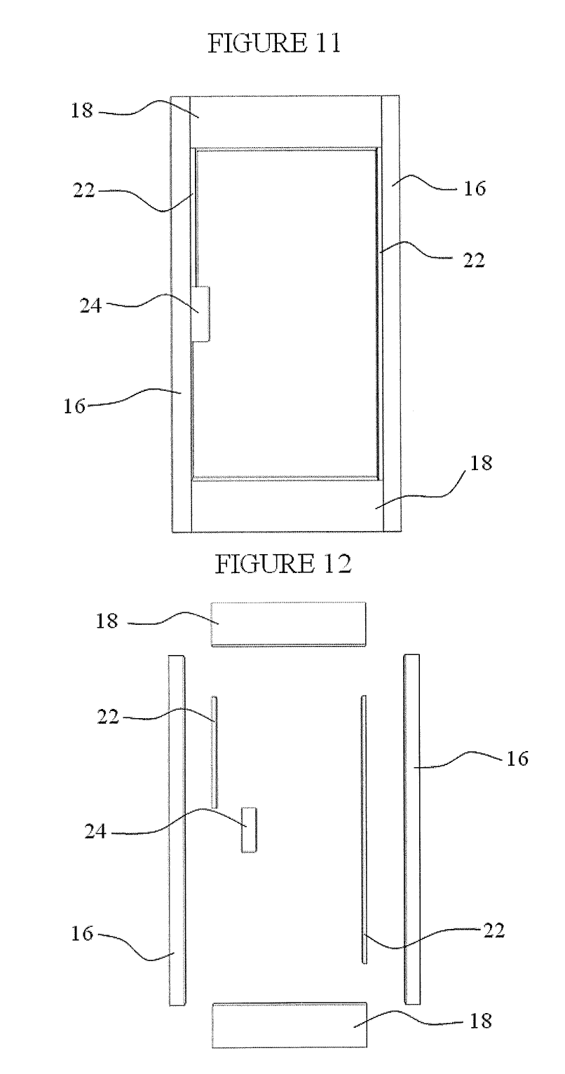

As best shown in FIGS. 9-12, the reinforcement member 22, may extend from a top rail 18 to a lock block 24 joined to the stile. The lock block 24 is typically a solid block of wood mounted to the stile 16 which provides support for a handle and/or door bolt. The door frame may also include hinge blocks (not shown) on the opposite stile to provide support to hinge assemblies. As best shown in FIGS. 11 and 12, a reinforcement member 22 extending from a rail 18 to a lock block 24 may be used in connection with a second reinforcement member 22 on a second stile 16 extending continuously from the top rail to the bottom rail.

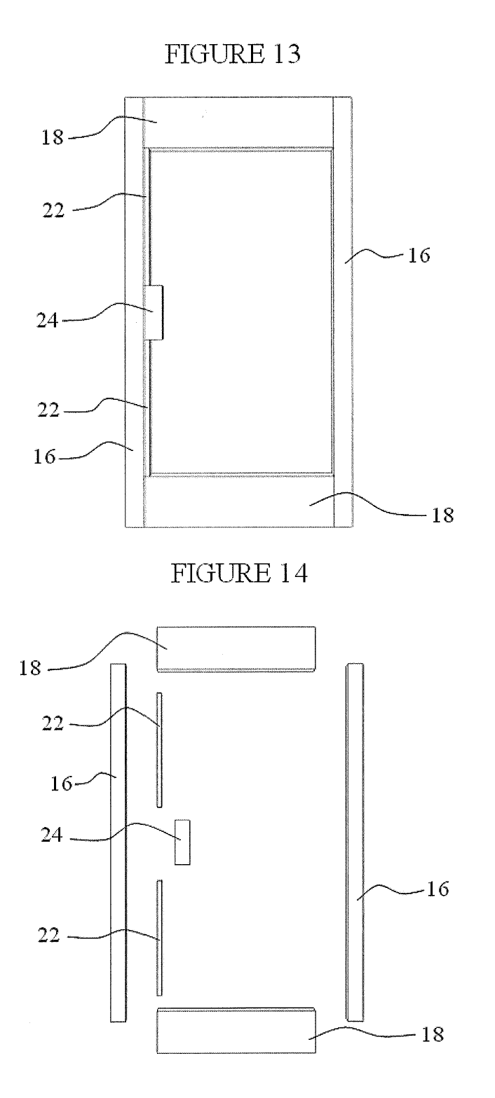

As best shown in FIGS. 13 and 14, the frame may include more than one reinforcement member 22 attached to a single stile 16. More than one reinforcement member 22 may be used in connection with a stile 16 joined to a lock block 24. In various exemplary embodiments, the size of the reinforcement member 22 may be reduced, and one or more reinforcement elements 22 may be selectively positioned along the stile to reduce or prevent warping. Analysis, such as testing or analytic computations, may be performed to determine the optimal position, number, and length of the reinforcement members 22 to reduce or prevent warping.

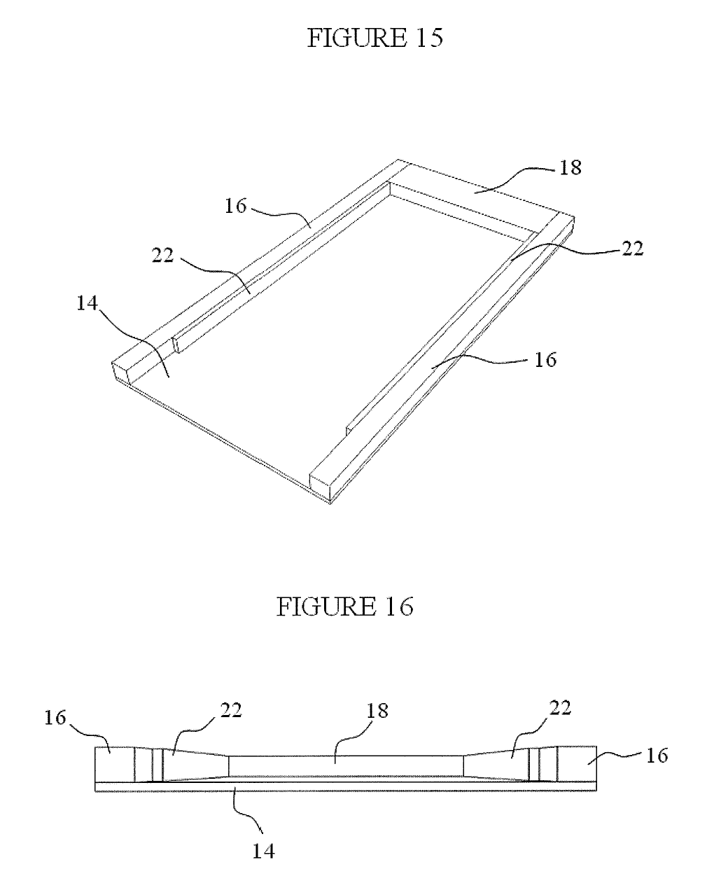

As best shown in FIGS. 15 and 16, the reinforcement member 22 may have a height that matches the height of the stile 16, for example, in the range of about 1.375-1.625 inches. The height of the reinforcement member may be less or more, however, depending on the style of the door facings 12, 14. The reinforcement member 22 may also vary in width depending on the design requirements of the door. For example, for a door intended to be used in regions that have a higher incidence or a greater amount of bowing, a wider reinforcement member 22 may be used. In an exemplary embodiment, the reinforcement member may have a width in the range of about 0.125-0.375 inches.

The reinforcement member 22 may be joined to the frame as part of a manual or automated assembly process. A first reinforcement member 22 is positioned near a first stile 16. The first reinforcement member 22 is then joined with the first stile 16, for example, by an adhesive connection and/or by a mechanical fastener. If an adhesive connection is used, the first stile 16, the first reinforcement member 22, or both may be coated with an adhesive on an appropriate contact surface. Once assembled, the parts may be clamped or otherwise held in place until the adhesive cures or reaches a certain bond strength. In various exemplary embodiments, more than one reinforcement member 22 may be attached to the first stile in this manner, either simultaneously or sequentially. In this way, a lock block 24 or hinge block may also be joined to the first stile 16, either before or after attachment of the reinforcement member(s) 22. Similarly, one or more reinforcement members 22, lock blocks 24, hinge blocks, or any combination thereof may be joined to a second stile 16. If desired, one or more reinforcement members 22 may be joined to a first and second rail 18. The first and second stiles 16 may then be joined with two or more rails 18 to form a frame. The stiles 16 and rails 18 may be attached to one another through an adhesive, mechanical fastener, interference fit, or any combination thereof. The frame may then be utilized in a desired structure, for example a door, door lite, side lite, or a window. In an exemplary embodiment where the frame is used with a door, an adhesive may be applied to a top surface of the frame. A first door skin may then be placed onto the top surface of the frame. The frame may then be rotated or flipped and an adhesive applied to an opposite, bottom surface of the frame. A second door skin may then be placed onto the bottom surface of the frame.

The foregoing detailed description of the certain exemplary embodiments has been provided for the purpose of explaining the principles of the invention and its practical application, thereby enabling others skilled in the art to understand the invention for various embodiments and with various modifications as are suited to the particular use contemplated. This description is not necessarily intended to be exhaustive or to limit the invention to the precise embodiments disclosed. Any of the embodiments and/or elements disclosed herein may be combined with one another to foam various additional embodiments not specifically disclosed. Accordingly, additional embodiments are possible and are intended to be encompassed within this specification and the scope of the appended claims. The specification describes specific examples to accomplish a more general goal that may be accomplished in another way.

Only those claims which use the words “means for” are to be interpreted under 35 U.S.C. 112, sixth paragraph.

1. A frame comprising:
a first stile having a first exterior surface and a first interior surface;
a second stile having a second exterior surface and a second interior surface;
a first rail joined to the first and second stile;
a second rail joined to the first and second stile; and
a reinforcement member joined to the first interior surface.

2. The frame of claim 1, wherein the reinforcement member reduces thermal warping of a door skin attached to the door frame.

3. The frame of claim 1, wherein the reinforcement member comprises a fiber reinforcement.

4. The frame of claim 1, wherein the fiber reinforcement comprises glass rovings and glass mats.

5. The frame of claim 1, wherein the reinforcement member comprises a fiber reinforced polymer.

6. The frame of claim 5, wherein the fiber reinforced polymer is a pultruded flat stock.

7. The frame of claim 1, wherein the reinforcement member is joined to the stile by an adhesive.

8. The frame of claim 7, wherein the adhesive comprises a cross-linking adhesive.

9. The frame of claim 7, wherein the adhesive is selected from the group consisting of a liquid cure adhesive, a hot melt adhesive, and an epoxy.

10. The frame of claim 1, wherein the reinforcement member extends along the stile between the first rail and the second rail.

11. The frame of claim 1, further comprising a lock block joined to the first interior surface.

12. The frame of claim 11, wherein the reinforcement member extends along the stile between the first rail and the lock block.

13. The frame of claim 1, wherein the reinforcement member is a first reinforcement member and the frame further comprises a second reinforcement member joined to the second interior surface.

14. The frame of claim 1, wherein the reinforcement member is a first reinforcement member and the frame further comprises a second reinforcement member joined to the first rail.

15. The frame of claim 1, wherein the frame is selected from the group consisting of a door frame, a window frame, a door lite frame, and a side lite frame.

16. A door comprising:
a first stile having a first top surface, a first bottom surface, a first exterior surface and a first interior surface;
a second stile having a second top surface, a second bottom surface, a second exterior surface and a second interior surface;
a first rail joined to the first and second stile;
a second rail joined to the first and second stile;
a reinforcement member joined to the first interior surface;
a first door skin joined to the first top surface of the first stile and the second top surface of the second stile; and
a second door skin joined to the first bottom surface of the first stile and the second bottom surface of the second stile.

17. The door of claim 16, wherein the first and second door skin comprise a composite material.

18. The door of claim 17, wherein the composite material comprises resin.

19. The door of claim 17, wherein the composite material comprises a sheet molding compound.

20. The door of claim 16, wherein the reinforcement member reduces thermal warping of a door skin attached to the door frame.

21. The door of claim 16, wherein the reinforcement member extends along the stile between the first rail and the second rail.

22. The door of claim 16, further comprising a lock block joined to the first interior surface.

23. The door of claim 22, wherein the reinforcement member extends along the stile between the first rail and the lock block.

24. The door of claim 16, wherein the reinforcement member is a first reinforcement member and the frame further comprises a second reinforcement member joined to the second interior surface.

25. The door of claim 16, wherein the reinforcement member is a first reinforcement member and the frame further comprises a second reinforcement member joined to the first rail.

26. The door of claim 16, further comprising a core positioned between the first and second door skins.

27-29. (canceled)
